(19) United States
(12) Patent Application Publication
(10) Pub. No.: US 2007/0158937 A1
(43) Pub. Date: Jul. 12, 2007

(54) Scrapbook assembly apparatus

(76) Inventor: Karen Kinne, Holland, MI (US)

Correspondence Address: King & Partners, PLC, 170 College Avenue, SUITE 230, HOLLAND, MI, 49423, US

(21) Appl. No.: 11/329,003

(22) Filed: Jan. 10, 2006

(51) Int. Cl. B42D 1/08

(52) U.S. Cl. 281/22

(57) ABSTRACT

A scrapbook assembly apparatus, comprising: (a) a first substrate, comprising: (1) an upper surface; (2) a lower surface; (3) an upper edge; (4) a lower edge; (5) a first side edge; and (6) a second side edge; (b) a second substrate, comprising: (1) an upper surface; (2) a lower surface; (3) an upper edge; (4) a lower edge, wherein the lower edge of the second substrate is hingeably associated with the lower edge of the first substrate; (5) a first side edge; and (6) a second side edge; (c) a third substrate, comprising: (1) an upper surface; (2) a lower surface; (3) an upper edge; (4) a lower edge, wherein the lower edge of the third substrate is hingeably associated with the lower edge of the second substrate; (5) a first side edge; and (6) a second side edge; (d) a first cavity; and (e) a second cavity.

### BACKGROUND OF THE INVENTION

1. Field of the Invention

The present invention relates in general to a scrapbook assembly apparatus, and more particularly, to a scrapbook assembly apparatus which is operatively configured to releasably secure a plurality of background papers, pictures, and/or ornamental indicia for easily arranging and rearranging a scrapbook layout.

2. Background Art

Scrapbook apparatuses have been known in the art for several years. To be sure, scrapbooking has gained popularity as an artistic and creative way to organize and display pictures, awards, special documents, etcetera. Typically, scrapbook layouts are assembled by laying a piece of background paper or cardstock as the first layer, laying pictures and/or ornamental indicia directly thereon as the second layer, laying other pictures and/or ornamental indicia directly thereon as the third layer, etcetera. In this way, multiple layers of background papers, pictures, and other ornamental indicia are arranged in order to create a decorative and personalized scrapbook layout.

Typically, during assembly of a scrapbook layout, it is often necessary to arrange and rearrange the background papers, pictures, and ornamental indicia in order to create the most pleasing effect. To be sure, different colors, sizes, and shapes of papers, pictures, and ornamental indicia are often experimented with until a final layout is decided upon. However, such arranging and rearranging of any of the lower layers of pictures, ornamental indicia, and/or background paper is quite cumbersome inasmuch as the upper layers of pictures, ornamental indicia, and/or background paper must be disturbed. Therefore, it is highly desirable to provide a scrapbook assembly apparatus which allows a user to easily arrange and rearrange a plurality of background papers, pictures, and/or ornamental indicia for a scrapbook layout without disturbing the other layers.

Furthermore, scrapbook layouts are sometimes assembled in a home. However, it is also gaining popularity to transport a scrapbook and/or scrapbook layouts in order to assemble a layout while at a scrapbook store, or during a scrapbook clinic or party. Typically, scrapbook layouts must be glued or otherwise permanently affixed in order to secure the background paper, pictures, and other ornamental indicia into the desired arrangement before transport. However, it is also desirable to assemble a scrapbook layout and move it to a different location without permanently affixing the layout into place. As such, a scrapbook assembly apparatus which allows a user to releasably secure a plurality of background papers, pictures, and/or ornamental indicia for a scrapbook layout is highly desirable.

Accordingly, it is an object of the present invention to overcome the deficiencies of the prior art and to satisfy the commercial demand for a scrapbook assembly apparatus which is operatively configured to releasably secure a plurality of background papers, pictures, and/or ornamental indicia for easily arranging and rearranging a scrapbook layout.

These and other objects of the present invention will become apparent in light of the present specification, claims, and drawings.

### SUMMARY OF THE INVENTION

The present invention is directed to a scrapbook assembly apparatus, comprising: (a) a first substrate, wherein the first substrate is substantially transparent, and wherein the first substrate comprises: (1) an upper surface; (2) a lower surface; (3) an upper edge; (4) a lower edge; (5) a first side edge; and (6) a second side edge; (b) a second substrate, wherein the second substrate is substantially transparent, and wherein the second substrate is spaced apart from the first substrate to define a first cavity therebetween, and wherein the second substrate comprises: (1) an upper surface, wherein at least a portion of the upper surface of the second substrate is capable of substantial abutment with at least a portion of the lower surface of the first substrate to substantially enclose a first cavity; (2) a lower surface; (3) an upper edge; (4) a lower edge, wherein the lower edge of the second substrate is hingeably associated with the lower edge of the first substrate; (5) a first side edge; and (6) a second side edge; (c) a third substrate, wherein the third substrate is spaced apart from the second substrate to define a second cavity therebetween, and wherein the third substrate comprises: (1) an upper surface, wherein at least a portion of the upper surface of the third substrate is capable of substantial abutment with at least a portion of the lower surface of the second substrate to substantially enclose a second cavity; (2) a lower surface; (3) an upper edge; (4) a lower edge, wherein the lower edge of the third substrate is hingeably associated with the lower edge of the second substrate; (5) a first side edge; and (6) a second side edge; (d) a first cavity, wherein the first cavity comprises an open configuration when the lower surface of the first substrate is spaced apart from the upper surface of the second substrate, and wherein the first cavity comprises a closed configuration when at least a portion of the lower surface of the first substrate is in substantial abutment with at least a portion of the upper surface of the second substrate; and (e) a second cavity, wherein the second cavity comprises an open configuration when the lower surface of the second substrate is spaced apart from the upper surface of the third substrate, and wherein the second cavity comprises a closed configuration when at least a portion of the lower surface of the second substrate is in substantial abutment with at least a portion of the upper surface of the third substrate.

In a preferred embodiment of the present invention, at least one of the group comprising the first substrate, the second substrate, and the third substrate comprises a substantially rectangular configuration.

In another preferred embodiment of the present invention, at least one of the group comprising the upper surface of the first substrate, the upper surface of the second substrate, and the upper surface of the third substrate is capable of generating attractive static electricity forces thereon.

In yet another preferred embodiment of the present invention, each of the first substrate and the second substrate further comprises a tab.

It is preferred that: (a) the open configuration of the first cavity comprises the first cavity being open between the upper edge of the first substrate and the upper edge of the second substrate, the first side edge of the first substrate and the first side edge of the second substrate, and the second side edge of the first substrate and the second side edge of the second substrate; and (b) the open configuration of the second cavity comprises the second cavity being open between the upper edge of the second substrate and the upper edge of the third substrate, the first side edge of the second substrate and the first side edge of the third substrate, and the second side edge of the second substrate and the second side edge of the third substrate.

It is also preferred that the scrapbook assembly apparatus further comprises: (a) at least one picture or ornamental indicia, wherein the at least one picture or ornamental indicia is releasably secured within the first cavity; and (b) at least one background paper, wherein the at least one background paper is releasably secured within the second cavity.

In another preferred embodiment of the present invention, the third substrate is substantially transparent.

In this embodiment, it is preferred that the scrapbook assembly apparatus further comprises: (a) a fourth substrate, wherein the fourth substrate is spaced apart from the third substrate to define a third cavity therebetween, and wherein the fourth substrate comprises: (1) an upper surface, wherein at least a portion of the upper surface of the fourth substrate is capable of substantial abutment with at least a portion of the lower surface of the third substrate to substantially enclose a third cavity; (2) a lower surface; (3) an upper edge; (4) a lower edge, wherein the lower edge of the fourth substrate is hingeably associated with the lower edge of the third substrate; (5) a first side edge; and (6) a second side edge; and (b) a third cavity, wherein the third cavity comprises an open configuration when the lower surface of the third substrate is spaced apart from the upper surface of the fourth substrate, and wherein the third cavity comprises a closed configuration when at least a portion of the lower surface of the third substrate is in substantial abutment with at least a portion of the upper surface of the fourth substrate.

In this embodiment, it is also preferred that the scrapbook assembly apparatus further comprises: (a) at least one picture or ornamental indicia, wherein the at least one picture or ornamental indicia is releasably secured within the first cavity; (b) at least one second picture or ornamental indicia, wherein the at least one second picture or ornamental indicia is releasably secured within the second cavity; and (c) at least one background paper, wherein the at least one background paper is releasably secured within the third cavity.

The present invention is also directed to a scrapbook assembly apparatus, comprising: (a) a first substrate, wherein the first substrate is substantially transparent, and wherein the first substrate comprises: (1) an upper surface; (2) a lower surface; (3) an upper edge; (4) a lower edge; (5) a first side edge; and (6) a second side edge; (b) a second substrate, wherein the second substrate is substantially transparent, and wherein the second substrate is spaced apart from the first substrate to define a first cavity therebetween, and wherein the second substrate comprises: (1) an upper surface, wherein at least a portion of the upper surface of the second substrate is capable of substantial abutment with at least a portion of the lower surface of the first substrate to substantially enclose a first cavity; (2) a lower surface; (3) an upper edge; (4) a lower edge, wherein the lower edge of the second substrate is hingeably associated with the lower edge of the first substrate; (5) a first side edge; and (6) a second side edge; (c) a third substrate, wherein the third substrate is substantially transparent, and wherein the third substrate is spaced apart from the second substrate to define a second cavity therebetween, and wherein the third substrate comprises: (1) an upper surface, wherein at least a portion of the upper surface of the third substrate is capable of substantial abutment with at least a portion of the lower surface of the second substrate to substantially enclose a second cavity; (2) a lower surface; (3) an upper edge; (4) a lower edge, wherein the lower edge of the third substrate is hingeably associated with the lower edge of the second substrate; (5) a first side edge; and (6) a second side edge; (d) a fourth substrate, wherein the fourth substrate is spaced apart from the third substrate to define a third cavity therebetween, and wherein the fourth substrate comprises: (1) an upper surface, wherein at least a portion of the upper surface of the fourth substrate is capable of substantial abutment with at least a portion of the lower surface of the third substrate to substantially enclose a third cavity; (2) a lower surface; (3) an upper edge; (4) a lower edge; (5) a first side edge; and (6) a second side edge, wherein the second side edge of the fourth substrate is hingeably associated with the second side edge of the third substrate; (e) a first cavity, wherein the first cavity comprises an open configuration when the lower surface of the first substrate is spaced apart from the upper surface of the second substrate, and wherein the first cavity comprises a closed configuration when at least a portion of the lower surface of the first substrate is in substantial abutment with at least a portion of the upper surface of the second substrate; (f) a second cavity, wherein the second cavity comprises an open configuration when the lower surface of the second substrate is spaced apart from the upper surface of the third substrate, and wherein the second cavity comprises a closed configuration when at least a portion of the lower surface of the second substrate is in substantial abutment with at least a portion of the upper surface of the third substrate; and (g) a third cavity, wherein the third cavity comprises an open configuration when the lower surface of the third substrate is spaced apart from the upper surface of the fourth substrate, and wherein the third cavity comprises a closed configuration when at least a portion of the lower surface of the third substrate is in substantial abutment with at least a portion of the upper surface of the fourth substrate.

In a preferred embodiment of the present invention, at least one of the group comprising the first substrate, the second substrate, the third substrate, and the fourth substrate comprises a substantially rectangular configuration.

In another preferred embodiment of the present invention, at least one of the group comprising the upper surface of the first substrate, the upper surface of the second substrate, the upper surface of the third substrate, and the upper surface of the fourth substrate is capable of generating attractive static electricity forces thereon.

In yet another preferred embodiment of the present invention, each of the first substrate, the second substrate, and the third substrate further comprises a tab.

It is preferred that: (a) the open configuration of the first cavity comprises the first cavity being open between the upper edge of the first substrate and the upper edge of the second substrate, the first side edge of the first substrate and the first side edge of the second substrate, and the second side edge of the first substrate and the second side edge of the second substrate; (b) the open configuration of the second cavity comprises the second cavity being open between the upper edge of the second substrate and the upper edge of the third substrate, the first side edge of the second substrate and the first side edge of the third substrate, and the second side edge of the second substrate and the second side edge of the third substrate; and (c) the open configuration of the third cavity comprises the third cavity being open between the upper edge of the third substrate and the upper edge of the fourth substrate, the lower edge of the third substrate and the lower edge of the fourth substrate, and the first side edge of the third substrate and the first side edge of the fourth substrate.

In another preferred embodiment of the present invention, the fourth substrate is substantially transparent.

The present invention is also directed to a scrapbook assembly apparatus, comprising: (a) a first substrate, wherein the first substrate is substantially transparent, and wherein the first substrate comprises: (1) an upper surface; (2) a lower surface; (3) an upper edge; (4) a lower edge; (5) a first side edge; and (6) a second side edge; (b) a second substrate, wherein the second substrate is substantially transparent, and wherein the second substrate is spaced apart from the first substrate to define a first cavity therebetween, and wherein the second substrate comprises: (1) an upper surface, wherein at least a portion of the upper surface of the second substrate is capable of substantial abutment with at least a portion of the lower surface of the first substrate to substantially enclose a first cavity; (2) a lower surface; (3) an upper edge; (4) a lower edge, wherein the lower edge of the second substrate is hingeably associated with the lower edge of the first substrate; (5) a first side edge; and (6) a second side edge; (c) a third substrate, wherein the third substrate is substantially transparent, and wherein the third substrate is spaced apart from the second substrate to define a second cavity therebetween, and wherein the third substrate comprises: (1) an upper surface, wherein at least a portion of the upper surface of the third substrate is capable of substantial abutment with at least a portion of the lower surface of the second substrate to substantially enclose a second cavity; (2) a lower surface; (3) an upper edge; (4) a lower edge, wherein the lower edge of the third substrate is hingeably associated with the lower edge of the second substrate; (5) a first side edge; and (6) a second side edge; (d) a fourth substrate, wherein the fourth substrate is spaced apart from the third substrate to define a third cavity therebetween, and wherein the fourth substrate comprises: (1) an upper surface, wherein at least a portion of the upper surface of the fourth substrate is capable of substantial abutment with at least a portion of the lower surface of the third substrate to substantially enclose a third cavity; (2) a lower surface; (3) an upper edge; (4) a lower edge; (5) a first side edge; and (6) a second side edge, wherein the second side edge of the fourth substrate is hingeably associated with the second side edge of the third substrate; (e) a first cavity, wherein the first cavity comprises an open configuration when the lower surface of the first substrate is spaced apart from the upper surface of the second substrate, and wherein the first cavity comprises a closed configuration when at least a portion of the lower surface of the first substrate is in substantial abutment with at least a portion of the upper surface of the second substrate; (f) a second cavity, wherein the second cavity comprises an open configuration when the lower surface of the second substrate is spaced apart from the upper surface of the third substrate, and wherein the second cavity comprises a closed configuration when at least a portion of the lower surface of the second substrate is in substantial abutment with at least a portion of the upper surface of the third substrate; (g) a third cavity, wherein the third cavity comprises an open configuration when the lower surface of the third substrate is spaced apart from the upper surface of the fourth substrate, and wherein the third cavity comprises a closed configuration when at least a portion of the lower surface of the third substrate is in substantial abutment with at least a portion of the upper surface of the fourth substrate; (h) at least one picture or ornamental indicia, wherein the at least one picture or ornamental indicia is releasably secured within the first cavity; (i) at least one second picture or ornamental indicia, wherein the at least one second picture or ornamental indicia is releasably secured within the second cavity; and (j) at least one background paper, wherein the at least one background paper is releasably secured within the third cavity.

In a preferred embodiment of the present invention, at least one of the group comprising the first substrate, the second substrate, the third substrate, and the fourth substrate comprises a substantially rectangular configuration.

In another preferred embodiment of the present invention, at least one of the group comprising the upper surface of the first substrate, the upper surface of the second substrate, the upper surface of the third substrate, and the upper surface of the fourth substrate is capable of generating attractive static electricity forces thereon.

In yet another preferred embodiment of the present invention, each of the first substrate, the second substrate, and the third substrate further comprises a tab.

It is preferred that: (a) the open configuration of the first cavity comprises the first cavity being open between the upper edge of the first substrate and the upper edge of the second substrate, the first side edge of the first substrate and the first side edge of the second substrate, and the second side edge of the first substrate and the second side edge of the second substrate; (b) the open configuration of the second cavity comprises the second cavity being open between the upper edge of the second substrate and the upper edge of the third substrate, the first side edge of the second substrate and the first side edge of the third substrate, and the second side edge of the second substrate and the second side edge of the third substrate; and (c) the open configuration of the third cavity comprises the third cavity being open between the upper edge of the third substrate and the upper edge of the fourth substrate, the lower edge of the third substrate and the lower edge of the fourth substrate, and the first side edge of the third substrate and the first side edge of the fourth substrate.

### BRIEF DESCRIPTION OF THE DRAWINGS

The invention will now be described with reference to the drawings wherein:

FIG. 1 of the drawings is a fragmented perspective view of an embodiment of a scrapbook assembly apparatus showing, among other things, three substrates, fabricated in accordance with the present invention;

FIG. 2 of the drawings is a top, side perspective view of an embodiment of a scrapbook assembly apparatus showing, among other things, three substrates having tabs, fabricated in accordance with the present invention;

FIG. 3 of the drawings is a top perspective view of an embodiment of a scrapbook assembly apparatus showing, among other things, a background paper releasably securable within a second cavity, fabricated in accordance with the present invention;

FIG. 4 of the drawings is a top, side perspective view of an embodiment of a scrapbook assembly apparatus showing, among other things, at least one picture and/or other ornamental indicia releasably securable within a first cavity and a background paper releasably securable within a second cavity, fabricated in accordance with the present invention;

FIG. 5 of the drawings is a fragmented perspective view of an embodiment of a scrapbook assembly apparatus showing, among other things, four substrates, fabricated in accordance with the present invention;

FIG. 6 of the drawings is a top, side perspective view of an embodiment of a scrapbook assembly apparatus showing, among other things, four substrates having tabs, fabricated in accordance with the present invention;

FIG. 7 of the drawings is a top, side perspective view of an embodiment of a scrapbook assembly apparatus showing, among other things, at least one picture and/or other ornamental indicia releasably securable within a first cavity, at least one picture and/or other ornamental indicia releasably securable within a second cavity, and a background paper releasably securable within a third cavity, fabricated in accordance with the present invention;

FIG. 8 of the drawings is a fragmented perspective view of an embodiment of a scrapbook assembly apparatus showing, among other things, four substrates, fabricated in accordance with the present invention;

FIG. 9 of the drawings is a top, side perspective view of an embodiment of a scrapbook assembly apparatus showing, among other things, four substrates having tabs, fabricated in accordance with the present invention;

FIG. 10 of the drawings is a top, side perspective view of an embodiment of a scrapbook assembly apparatus showing, among other things, at least one picture and/or other ornamental indicia releasably securable within a first cavity, at least one picture and/or other ornamental indicia releasably securable within a second cavity, and a background paper releasably securable within a third cavity, fabricated in accordance with the present invention;

FIG. 11 of the drawings is an upper perspective view of an embodiment of a scrapbook assembly apparatus showing, among other things, a closed first cavity and a closed second cavity;

FIG. 12 of the drawings is an upper perspective view of an embodiment of a scrapbook assembly apparatus showing, among other things, a closed first cavity, a closed second cavity, and a closed third cavity; and

FIG. 13 of the drawings is a top, side perspective view of an embodiment of a stand for use in association with a scrapbook assembly apparatus, fabricated in accordance with the present invention.

### DETAILED DESCRIPTION OF THE INVENTION

While this invention is susceptible of embodiment in many different forms, there is shown in the drawings and will herein be described in detail a specific embodiment with the understanding that the present disclosure is to be considered as an exemplification of the principles of the invention and is not intended to limit the invention to the embodiment illustrated.

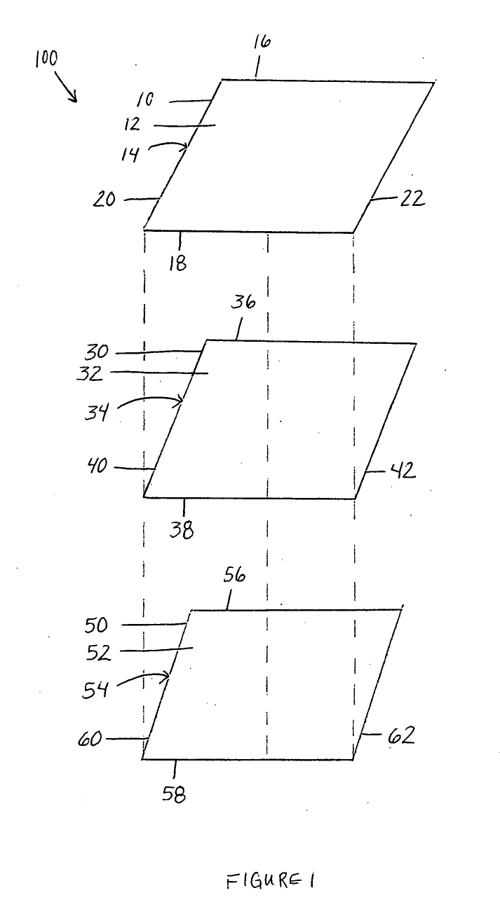

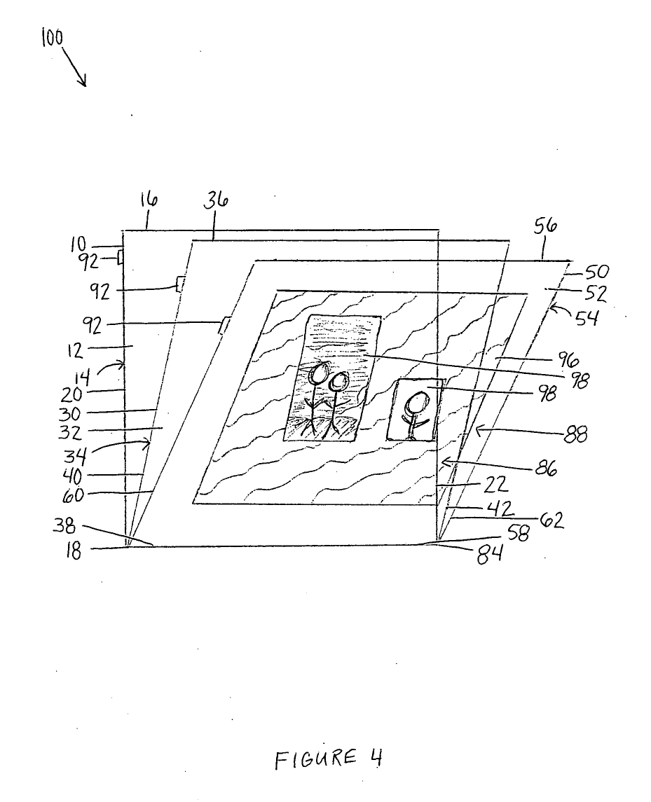

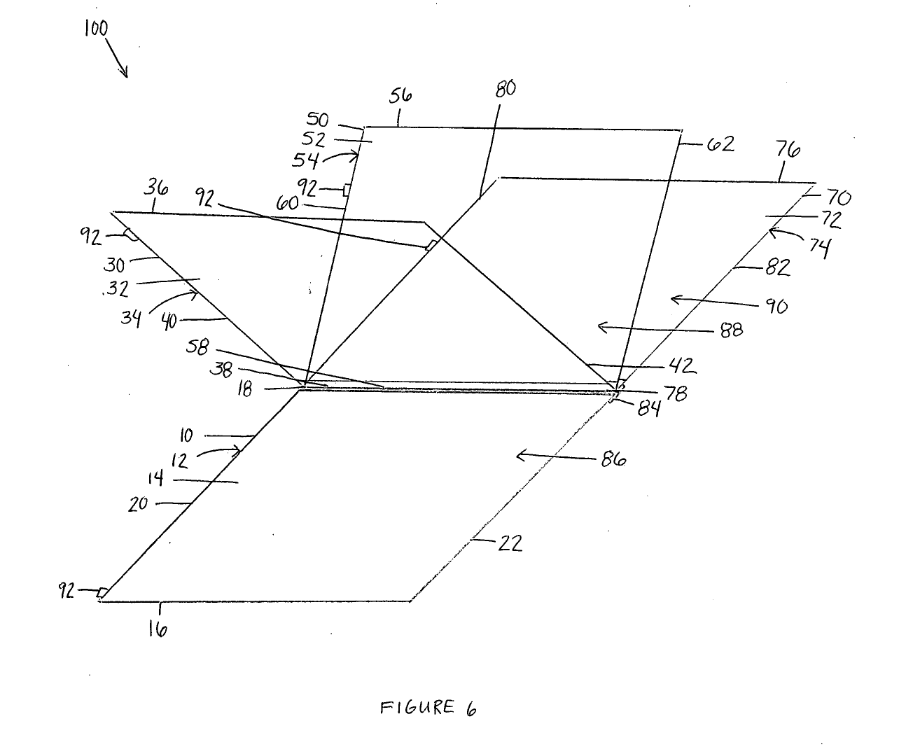

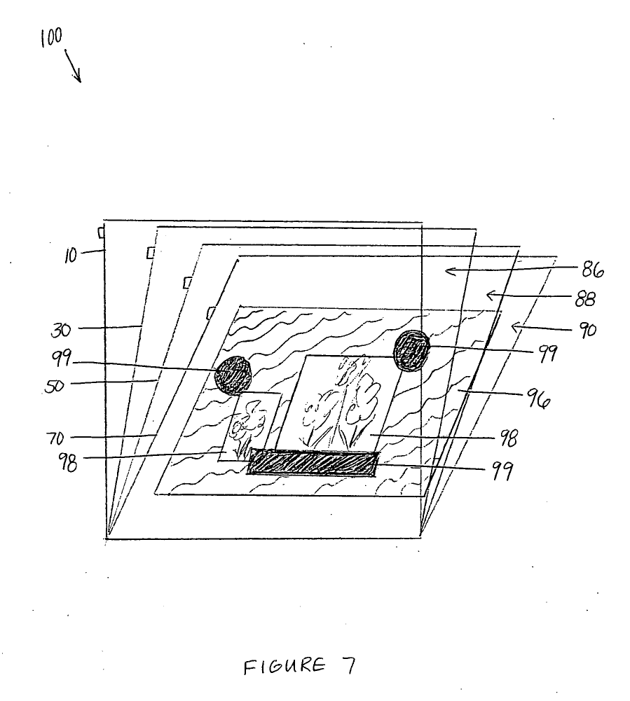

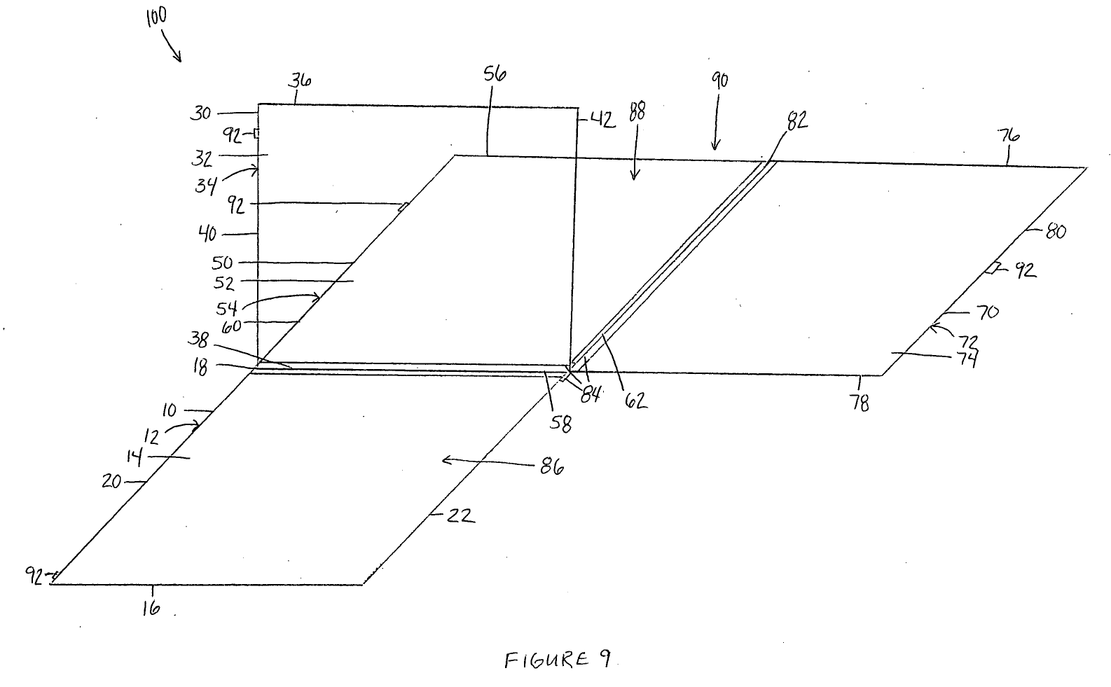

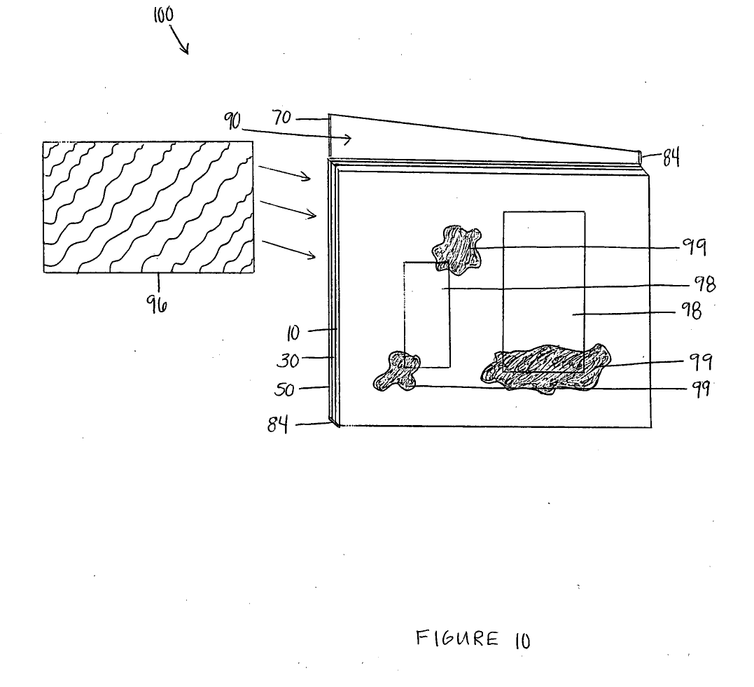

Referring now to the drawings and to FIGS. 1-4 in particular, perspective views of scrapbook assembly apparatus 100 are shown, which generally comprises first substrate 10, second substrate 30, third substrate 50, first cavity 86, and second cavity 88. While scrapbook assembly apparatus 100 is shown as comprising separate members comprising the same or different materials, which are fused, welded, fastened, or otherwise attached, it will be understood that a unitary member is also contemplated. In addition, while scrapbook assembly apparatus 100 is shown as comprising three or four substrates and two or three cavities, it will be understood that any number of substrates and cavities therebetween are contemplated. It will be understood that FIGS. 1 through 12 are merely schematic representations of scrapbook assembly apparatus 100. As such, some of the components may have been distorted from their actual scale for pictorial clarity.

First substrate 10 includes upper surface 12, lower surface 14, upper edge 16, lower edge 18, first side edge 20, and second side edge 22. As is shown in FIGS. 1-4, among others, it is preferred that first substrate 10 comprises a substantially linear, substantially rectangular shape which comprises a height ranging from between approximately 1 inch to approximately 30 inches, and preferably between approximately 5 inches to approximately 15 inches, and which comprises a length ranging from between approximately 1 inch to approximately 30 inches, and preferably between approximately 5 inches to approximately 15 inches. However, it will be understood that first substrate 10 may comprise any one of a number of different shapes and sizes, such as square, triangular, polygonal, circular, oblong, arcuate, or arbitrary, and may also be multi-dimensional. It is also preferred that at least a portion of first substrate 10 is fabricated from a substantially clear, substantially transparent material, in order for an individual to be able to see a picture, ornamental indicia, or background paper for a scrapbook therethrough. In addition, first substrate 10 is preferably fabricated from a material which is capable of generating attractive static electricity forces or other attractive forces thereon, in order for a picture, ornamental indicia, or background paper lying thereon to not slip from its intended position. As such, it is contemplated that scrapbook assembly apparatus 100 be fabricated from, for example, plexi-glass, however, it will be understood that first substrate 10 may be fabricated from any one of a number of natural and/or synthetic materials including numerous metals and alloys, plastics, woods, combinations of the same, etcetera.

Second substrate 30 includes upper surface 32, lower surface 34, upper edge 36, lower edge 38, first side edge 40, and second side edge 42. As is shown in FIGS. 1-4, among others, lower edge 38 of second substrate 30 is hingeably associated with lower edge 18 of first substrate 10 via attachment member 84. It is also contemplated that second side edge 42 of second substrate 30 is hingeably associated with second side edge 22 of first substrate 10 via attachment member 84. Attachment member 84 may comprise any one of a number of attaching means known to those with ordinary skill in the art, such as, but not limited to, welding, fusing, threaded and non-threaded fasteners, rivets, various tapes, and adhesives—just to name a few. As such, second substrate 30 is spaced apart from first substrate 10 to define first cavity 86 therebetween. It is preferred that second substrate 30 comprises a substantially linear, substantially rectangular shape which comprises a height ranging from between approximately 1 inch to approximately 30 inches, and preferably between approximately 5 inches to approximately 15 inches, and which comprises a length ranging from between approximately 1 inch to approximately 30 inches, and preferably between approximately 5 inches to approximately 15 inches. However, it will be understood that second substrate 30 may comprise any one of a number of different shapes and sizes, such as square, triangular, polygonal, circular, oblong, arcuate, or arbitrary, and may also be multi-dimensional. It is also preferred that at least a portion of second substrate 30 is fabricated from a substantially clear, substantially transparent material, in order for an individual to be able to see a picture, ornamental indicia, or background paper for a scrapbook therethrough. In addition, second substrate 30 is preferably fabricated from a material which is capable of generating attractive static electricity forces or other attractive forces thereon, in order for a picture, ornamental indicia, or background paper lying thereon to not slip from its intended position. As such, it is contemplated that scrapbook assembly apparatus 100 be fabricated from, for example, plexi-glass, however, it will be understood that second substrate 30 may be fabricated from any one of a number of natural and/or synthetic materials including numerous metals and alloys, plastics, woods, combinations of the same, etcetera.

Third substrate 50 includes upper surface 52, lower surface 54, upper edge 56, lower edge 58, first side edge 60, and second side edge 62. As is shown in FIGS. 1-4, among others, lower edge 58 of third substrate 50 is hingeably associated with lower edge 38 of second substrate 30 via attachment member 84. It is also contemplated that second side edge 62 of third substrate 50 is hingeably associated with second side edge 42 of second substrate 30 via attachment member 84. As such, third substrate 50 is spaced apart from second substrate 30 to define second cavity 88 therebetween. It is preferred that third substrate 50 comprises a substantially linear, substantially rectangular shape which comprises a height ranging from between approximately 1 inch to approximately 30 inches, and preferably between approximately 5 inches to approximately 15 inches, and which comprises a length ranging from between approximately 1 inch to approximately 30 inches, and preferably between approximately 5 inches to approximately 15 inches. However, it will be understood that third substrate 50 may comprise any one of a number of different shapes and sizes, such as square, triangular, polygonal, circular, oblong, arcuate, or arbitrary, and may also be multi-dimensional. It is also preferred that at least a portion of third substrate 50 is fabricated from a substantially clear, substantially transparent material, in order for an individual to be able to see a picture, ornamental indicia, or background paper for a scrapbook therethrough. In addition, third substrate 50 is preferably fabricated from a material which is capable of generating attractive static electricity forces or other attractive forces thereon, in order for a picture, ornamental indicia, or background paper lying thereon to not slip from its intended position. As such, it is contemplated that scrapbook assembly apparatus 100 be fabricated from, for example, plexi-glass, however, it will be understood that third substrate 50 may be fabricated from any one of a number of natural or synthetic materials including numerous metals and alloys, plastics, woods, combinations of the same, etcetera.

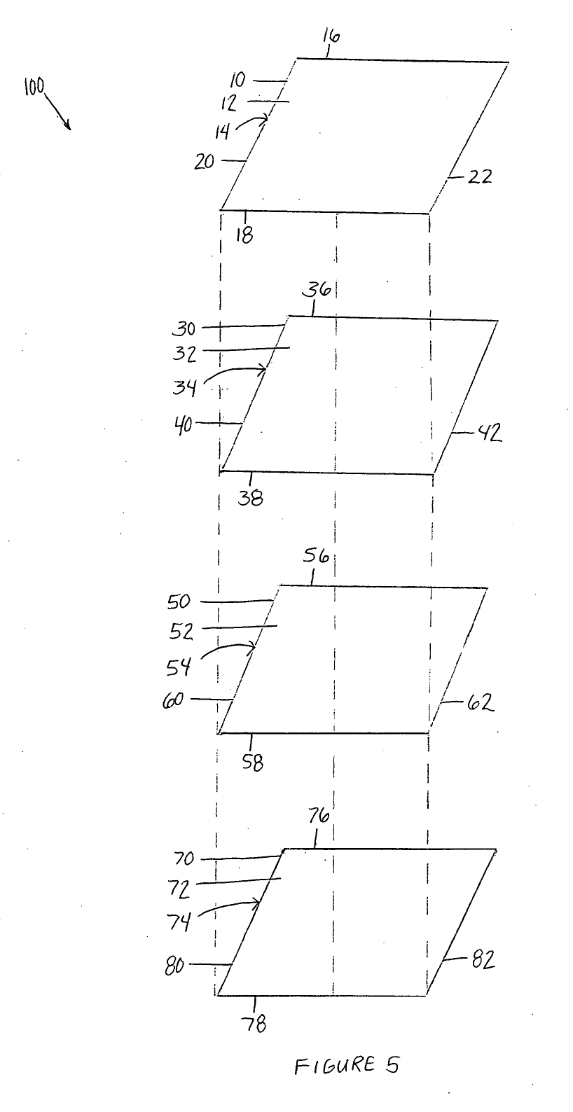

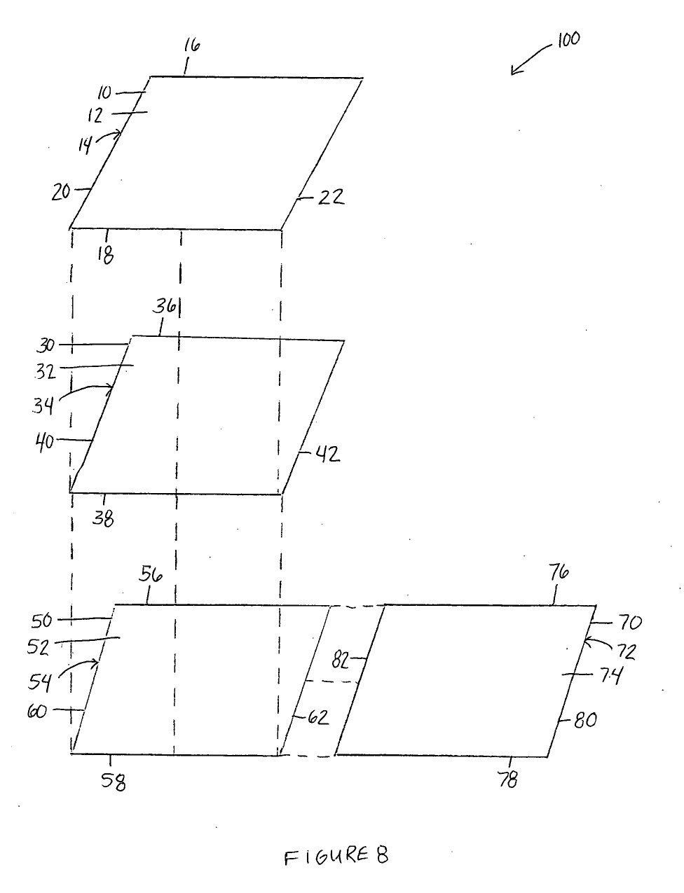

As is shown in FIGS. 5-10, among others, preferably, scrapbook assembly apparatus 100 further comprises fourth substrate 70. Fourth substrate 70 includes upper surface 72, lower surface 74, upper edge 76, lower edge 78, first side edge 80, and second side edge 82. As is shown in FIGS. 5-7, among others, lower edge 78 of fourth substrate 70 can be hingeably associated with lower edge 58 of third substrate 50 via attachment member 84. Alternatively, as is shown in FIGS. 8-10, among others, second side edge 82 of fourth substrate 70 can be hingeably associated with second side edge 62 of third substrate 50 via attachment member 84. As such, fourth substrate 70 is spaced apart from third substrate 50 to define third cavity 90 therebetween. It is preferred that fourth substrate 70 comprises a substantially linear, substantially rectangular shape which comprises a height ranging from between approximately 1 inch to approximately 30 inches, and preferably between approximately 5 inches to approximately 15 inches, and which comprises a length ranging from between approximately 1 inch to approximately 30 inches, and preferably between approximately 5 inches to approximately 15 inches. However, it will be understood that fourth substrate 70 may comprise any one of a number of different shapes and sizes, such as square, triangular, polygonal, circular, oblong, arcuate, or arbitrary, and may also be multi-dimensional. It is also preferred that at least a portion of fourth substrate 70 is fabricated from a substantially clear, substantially transparent material, in order for an individual to be able to see a picture, ornamental indicia, or background paper for a scrapbook therethrough. In addition, fourth substrate 70 is preferably fabricated from a material which is capable of generating attractive static electricity forces thereon, in order for a picture, ornamental indicia, or background paper lying thereon to not slip from its intended position. As such, it is contemplated that scrapbook assembly apparatus 100 be fabricated from, for example, plexi-glass, however, it will be understood that fourth substrate 70 may be fabricated from any one of a number of natural and/or synthetic materials including numerous metals and alloys, plastics, woods, combinations of the same, etcetera.

First substrate 10, second substrate 30, third substrate 50, and fourth substrate 70 may also each optionally comprise tab 92 thereon to assist an individual in quickly and easily raising or lowering a substrate to, in turn, open or close a cavity. Tab 92 may emanate contiguously from any one of the upper edge, lower edge, first side edge, and/or second side edge of the substrates or may be attached thereto by any one of a number of attaching means known to those with ordinary skill in the art, such as, but not limited to, welding, fusing, threaded and non-threaded fasteners, rivets, various tapes, and adhesives—just to name a few. In addition, first substrate 10, second substrate 30, third substrate 50, and fourth substrate 70 may each comprise at least one spacer, such as a silicon bead or other spacer known to those skilled in the art, attached to either the upper or lower surface of the respective substrate to provide protection for the surfaces of the substrates.

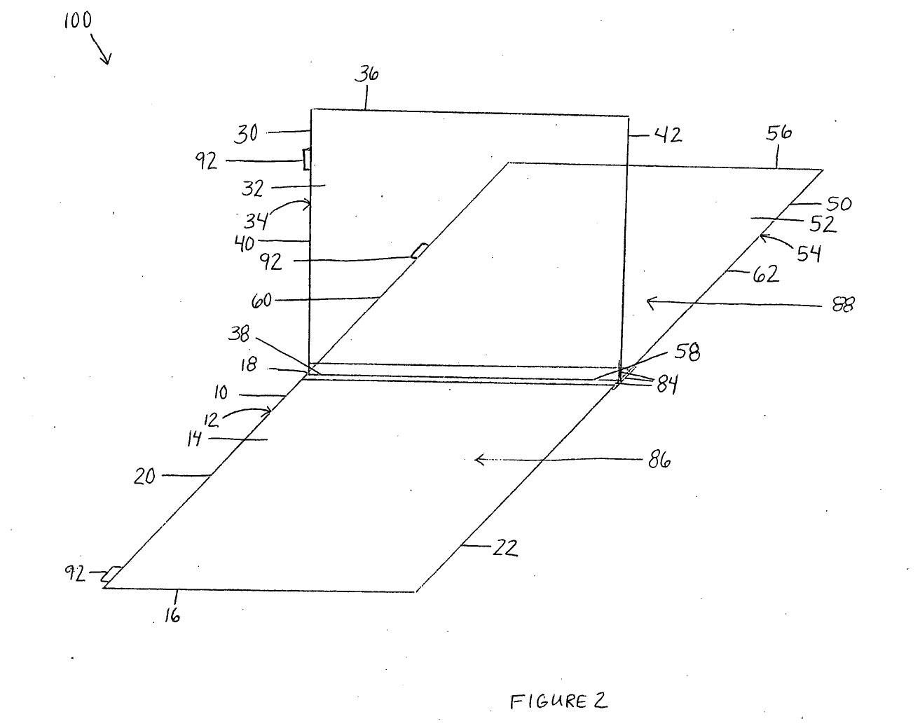

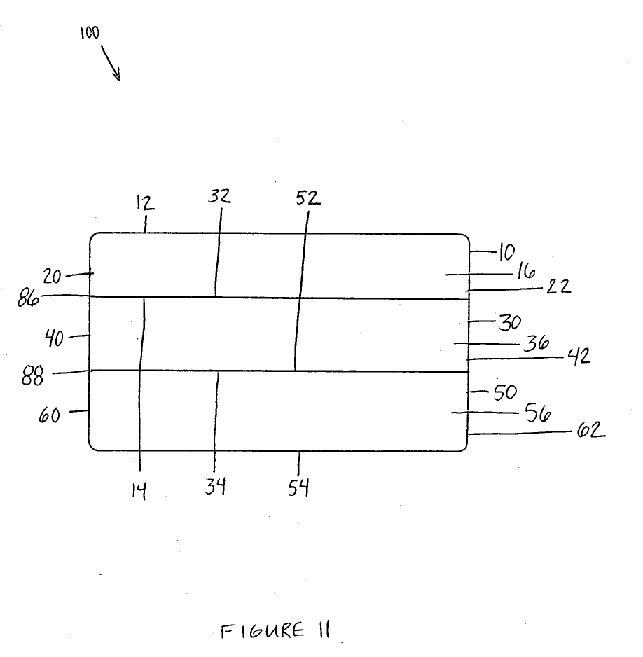

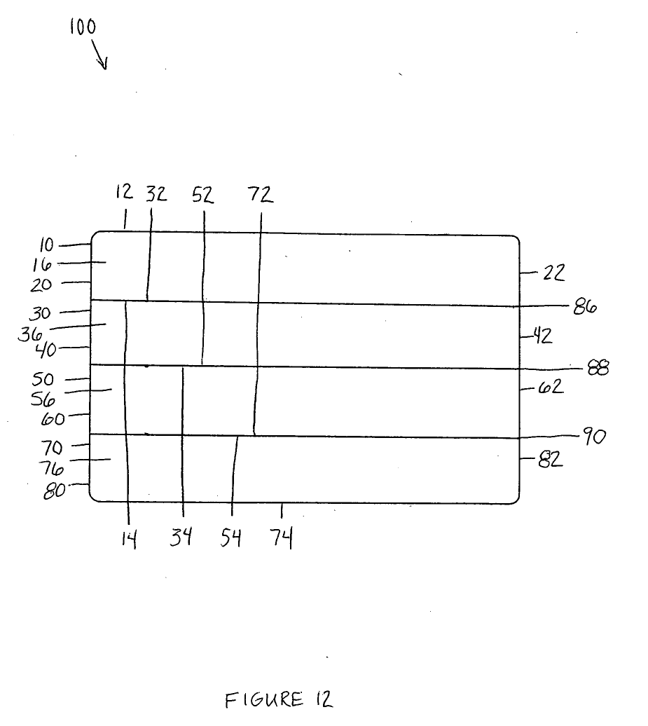

First cavity 86 is shown in FIGS. 2-4, among others, as comprising an open configuration when lower surface 14 of first substrate 10 is spaced apart from upper surface 32 of second substrate 30. In such an open configuration, first cavity 86 is open between upper edge 16 of first substrate 10 and upper edge 36 of second substrate 30, first side edge 20 of first substrate 10 and first side edge 40 of second substrate 30, and second side edge 22 of first substrate 10 and second side edge 42 of second substrate 30. First cavity 86 is shown in FIGS. 11 and 12, among others, as comprising a closed configuration when lower surface 14 of first substrate 10 is in substantial abutment with upper surface 32 of second substrate 30. Regardless of its ordinary meaning, “in substantial abutment” will be understood to mean that upper edge 16 of first substrate 10 and upper edge 36 of second substrate 30, first side edge 20 of first substrate 10 and first side edge 40 of second substrate 30, and second side edge 22 of first substrate 10 and second side edge 42 of second substrate 30 are in close enough proximity to substantially releasably secure background paper 96, pictures 98, and/or ornamental indicia 99 within first cavity 86, and may include “in substantial contact” and/or “substantially contiguous”.

Second cavity 88 is shown in FIGS. 2-4, among others, as comprising an open configuration when lower surface 34 of second substrate 30 is spaced apart from upper surface 52 of third substrate 50. In such an open configuration, second cavity 88 is open between upper edge 36 of second substrate 30 and upper edge 56 of third substrate 50, first side edge 40 of second substrate 30 and first side edge 60 of third substrate 50, and second side edge 42 of second substrate 30 and second side edge 62 of third substrate 50. Second cavity 88 is shown in FIGS. 11 and 12, among others, as comprising a closed configuration when lower surface 34 of second substrate 30 is in substantial abutment with upper surface 52 of third substrate 50. Regardless of its ordinary meaning, “in substantial abutment” will be understood to mean that upper edge 36 of second substrate 30 and upper edge 56 of third substrate 50, first side edge 40 of second substrate 30 and first side edge 60 of third substrate 50, and second side edge 42 of second substrate 30 and second side edge 62 of third substrate 50 are in close enough proximity to substantially releasably secure background paper 96, pictures 98, and/or ornamental indicia 99 within second cavity 88, and may include the meanings “in substantial contact” and/or “substantially contiguous”.

Third cavity 90 is shown in FIGS. 2-4, among others, as comprising an open configuration when lower surface 54 of third substrate 50 is spaced apart from upper surface 72 of fourth substrate 70. In such an open configuration, third cavity 90 is open between upper edge 56 of second substrate 30 and upper edge 76 of fourth substrate 70, first side edge 60 of third substrate 50 and first side edge 80 of fourth substrate 70, and second side edge 62 of third substrate 50 and second side edge 82 of fourth substrate 70. Third cavity 90 is shown in FIG. 12, among others, as comprising a closed configuration when lower surface 54 of third substrate 50 is in substantial abutment with upper surface 72 of fourth substrate 70. Regardless of its ordinary meaning, “in substantial abutment” will be understood to mean that upper edge 56 of third substrate 50 and upper edge 76 of fourth substrate 70, first side edge 60 of third substrate 50 and first side edge 80 of fourth substrate 70, and second side edge 62 of third substrate 50 and second side edge 82 of fourth substrate 70 are in close enough proximity to substantially releasably secure background paper 96, pictures 98, and/or ornamental indicia 99 within third cavity 90, and may include the meanings “in substantial contact” and/or “substantially contiguous”.

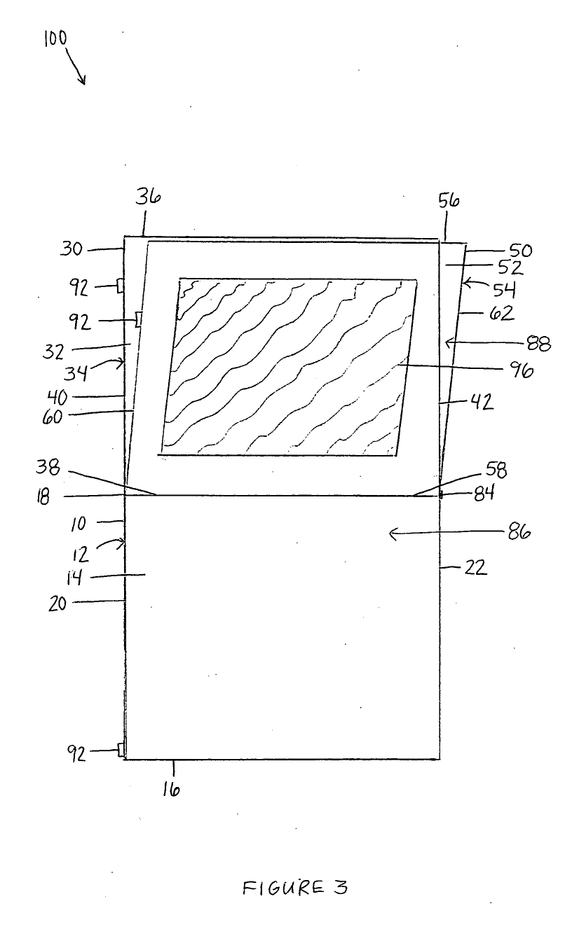

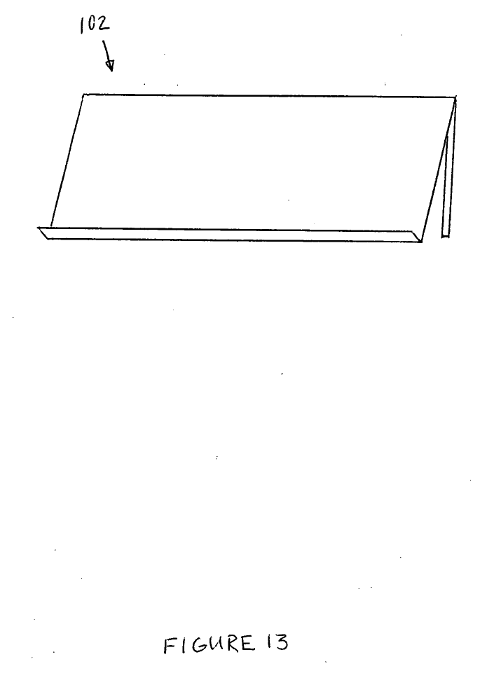

Preferably, as is shown in FIGS. 3, 4, 7, and 10, among others, scrapbook assembly apparatus 100 may further comprise at least one background paper 96, at least one picture 98, and/or ornamental indicia 99 which are releasably securable within first cavity 86, second cavity 88, and/or third cavity 90. Background paper 96 may comprise a sheet of paper or cardstock or any other background material known to those skilled in the art. Picture 98 may comprise a photograph, document, award, or other picture or memorabilia known to those skilled in the art. Ornamental indicia 99 may comprise a paper, cloth, wrapping, sticker, or other ornamental material known to those skilled in the art. In addition, as shown in FIG. 13, among others, scrapbook assembly apparatus 100 may further comprise a stand 102, for purposes of supporting scrapbook assembly apparatus 100 at an optimal viewing angle and for reduction of glare thereon.

An individual assembling a scrapbook layout can utilize scrapbook assembly apparatus 100 to releasably secure a plurality of background papers 96, pictures 98, and/or ornamental indicia 99 for easily arranging and rearranging a scrapbook layout. For example, in operation, scrapbook assembly apparatus 100 is provided which comprises, for example first substrate 10, second substrate 30, third substrate 50, first cavity 86, second cavity 88, at least one background paper 96, at least one picture 98, and at least one ornamental indicia 99.

Background paper 96 is placed within second cavity 88 in a specific position. To do so, second substrate 30 is hingeably raised away from third substrate 50, preferably via tab 92, in order to open second cavity 88. Specifically, upper edge 36 of second substrate 30 is raised away from upper edge 56 of third substrate 50, first side edge 40 of second substrate 30 is raised away from first side edge 60 of third substrate 50, and second side edge 42 of second substrate 30 is raised away from second side edge 62 of third substrate 50 while lower edge 38 of second substrate 30 is hingeably associated with lower edge 58 of third substrate 50. Background paper 96 can then be inserted into second cavity 88 between upper edge 36 of second substrate 30 and upper edge 56 of third substrate 50, first side edge 40 of second substrate 30 and first side edge 60 of third substrate 50, and/or second side edge 42 of second substrate 30 and second side edge 62 of third substrate 50. Preferably, upper surface 52 of third substrate 50 is capable of generating attractive static electricity forces thereon, and background paper 96 will be held in its proper position thereby. Second cavity 88 is then closed by hingeably lowering second substrate 30 such that lower surface 34 of second substrate 30 is in substantial abutment with upper surface 52 of third substrate 50 to, in turn, releasably secure background paper 96 within second cavity 88.

At least one picture 98 and/or ornamental indicia 99 is placed within first cavity 86 in a specific position. To do so, first substrate 10 is hingeably raised away from second substrate 30, preferably via tab 92, in order to open first cavity 86. Specifically, upper edge 16 of first substrate 10 is raised away from upper edge 36 of second substrate 30, first side edge 20 of first substrate 10 is raised away from first side edge 40 of second substrate 30, and second side edge 22 of first substrate 10 is raised away from second side edge 42 of second substrate 30 while lower edge 18 of first substrate 10 is hingeably associated with lower edge 38 of second substrate 30. At least one picture 98 and/or ornamental indicia 99 can then be inserted into first cavity 86 between upper edge 16 of first substrate 10 and upper edge 36 of second substrate 30, first side edge 20 of first substrate 10 and first side edge 40 of second substrate 30, and/or second side edge 22 of first substrate 10 and second side edge 42 of second substrate 30. Preferably, upper surface 32 of second substrate 30 is capable of generating attractive static electricity forces thereon, and at least one picture 98 and/or ornamental indicia 99 will be held in its proper position thereby. First cavity 86 is then closed by hingeably lowering first substrate 10 such that lower surface 14 of first substrate 10 is in substantial abutment with upper surface 32 of second substrate 30 to, in turn, releasably secure at least one picture 98 and/or ornamental indicia 99 within first cavity 86.

Typically, during assembly of a scrapbook layout, an individual must lay background paper 96, pictures 98, and/or ornamental indicia 99 directly on top of each other, which precludes easily rearranging the layout. As such, an individual may settle with the first layout he/she assembles instead of experimenting with several different layout possibilities. Scrapbook assembly apparatus 100 allows an individual to specifically position background papers 96, pictures 98, and ornamental indicia 99 in separate cavities 86, 88, and/or 90 of scrapbook assembly apparatus 100. As such, background paper 96 may be removed and exchanged with background paper 96 of a different color, shape, or size without disturbing pictures 98 or ornamental indicia 99, which are releasably secured in separate cavities. Likewise, pictures 98 may be removed and exchanged with different pictures 98 without disturbing background paper 96 or ornamental indicia 99, which are releasably secured in separate cavities, and ornamental indicia 99 may be removed and exchanged with different ornamental indicia 99 without disturbing background paper 96 or pictures 98, which are releasably secured in separate cavities.

While scrapbook assembly apparatus 100 has been disclosed primarily for the purposes of scrapbook assembly, it will be understood that numerous other applications for scrapbook assembly apparatus 100 are likewise contemplated for use such as, for example, interior/exterior design, graphic design including website and logo design, fashion design, architectural design, and scene design, just to name a few.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A scrapbook assembly apparatus, comprising:
a first substrate, wherein the first substrate is substantially transparent, and wherein the first substrate comprises:
an upper surface;
a lower surface;
an upper edge;
a lower edge;
a first side edge; and
a second side edge;
a second substrate, wherein the second substrate is substantially transparent, and wherein the second substrate is spaced apart from the first substrate to define a first cavity therebetween, and wherein the second substrate comprises:
an upper surface, wherein at least a portion of the upper surface of the second substrate is capable of substantial abutment with at least a portion of the lower surface of the first substrate to substantially enclose a first cavity;
a lower surface;
an upper edge;
a lower edge, wherein the lower edge of the second substrate is hingeably associated with the lower edge of the first substrate;
a first side edge; and
a second side edge;
a third substrate, wherein the third substrate is spaced apart from the second substrate to define a second cavity therebetween, and wherein the third substrate comprises:
an upper surface, wherein at least a portion of the upper surface of the third substrate is capable of substantial abutment with at least a portion of the lower surface of the second substrate to substantially enclose a second cavity;
a lower surface;
an upper edge;
a lower edge, wherein the lower edge of the third substrate is hingeably associated with the lower edge of the second substrate;
a first side edge; and
a second side edge;
a first cavity, wherein the first cavity comprises an open configuration when the lower surface of the first substrate is spaced apart from the upper surface of the second substrate, and wherein the first cavity comprises a closed configuration when at least a portion of the lower surface of the first substrate is in substantial abutment with at least a portion of the upper surface of the second substrate; and
a second cavity, wherein the second cavity comprises an open configuration when the lower surface of the second substrate is spaced apart from the upper surface of the third substrate, and wherein the second cavity comprises a closed configuration when at least a portion of the lower surface of the second substrate is in substantial abutment with at least a portion of the upper surface of the third substrate.

2. The scrapbook assembly apparatus according to claim 1, wherein at least one of the group comprising the first substrate, the second substrate, and the third substrate comprises a substantially rectangular configuration.

3. The scrapbook assembly apparatus according to claim 1, wherein at least one of the group comprising the upper surface of the first substrate, the upper surface of the second substrate, and the upper surface of the third substrate is capable of generating attractive static electricity forces thereon.

4. The scrapbook assembly apparatus according to claim 1, wherein each of the first substrate and the second substrate further comprises a tab.

5. The scrapbook assembly apparatus according to claim 1, wherein:
the open configuration of the first cavity comprises the first cavity being open between the upper edge of the first substrate and the upper edge of the second substrate, the first side edge of the first substrate and the first side edge of the second substrate, and the second side edge of the first substrate and the second side edge of the second substrate; and
the open configuration of the second cavity comprises the second cavity being open between the upper edge of the second substrate and the upper edge of the third substrate, the first side edge of the second substrate and the first side edge of the third substrate, and the second side edge of the second substrate and the second side edge of the third substrate.

6. The scrapbook assembly apparatus according to claim 1, wherein the scrapbook assembly apparatus further comprises:
at least one picture or ornamental indicia, wherein the at least one picture or ornamental indicia is releasably secured within the first cavity; and
at least one background paper, wherein the at least one background paper is releasably secured within the second cavity.

7. The scrapbook assembly apparatus according to claim 1, wherein the third substrate is substantially transparent.

8. The scrapbook assembly apparatus according to claim 7, wherein the scrapbook assembly apparatus further comprises:
a fourth substrate, wherein the fourth substrate is spaced apart from the third substrate to define a third cavity therebetween, and wherein the fourth substrate comprises:
an upper surface, wherein at least a portion of the upper surface of the fourth substrate is capable of substantial abutment with at least a portion of the lower surface of the third substrate to substantially enclose a third cavity;
a lower surface;
an upper edge;
a lower edge, wherein the lower edge of the fourth substrate is hingeably associated with the lower edge of the third substrate;
a first side edge; and
a second side edge; and
a third cavity, wherein the third cavity comprises an open configuration when the lower surface of the third substrate is spaced apart from the upper surface of the fourth substrate, and wherein the third cavity comprises a closed configuration when at least a portion of the lower surface of the third substrate is in substantial abutment with at least a portion of the upper surface of the fourth substrate.

9. The scrapbook assembly apparatus according to claim 8, wherein the scrapbook assembly apparatus further comprises:
at least one picture or ornamental indicia, wherein the at least one picture or ornamental indicia is releasably secured within the first cavity;
at least one second picture or ornamental indicia, wherein the at least one second picture or ornamental indicia is releasably secured within the second cavity; and
at least one background paper, wherein the at least one background paper is releasably secured within the third cavity.

10. A scrapbook assembly apparatus, comprising:
a first substrate, wherein the first substrate is substantially transparent, and wherein the first substrate comprises:
an upper surface;
a lower surface;
an upper edge;
a lower edge;
a first side edge; and
a second side edge;
a second substrate, wherein the second substrate is substantially transparent, and wherein the second substrate is spaced apart from the first substrate to define a first cavity therebetween, and wherein the second substrate comprises:
an upper surface, wherein at least a portion of the upper surface of the second substrate is capable of substantial abutment with at least a portion of the lower surface of the first substrate to substantially enclose a first cavity;
a lower surface;
an upper edge;
a lower edge, wherein the lower edge of the second substrate is hingeably associated with the lower edge of the first substrate;
a first side edge; and
a second side edge;
a third substrate, wherein the third substrate is substantially transparent, and wherein the third substrate is spaced apart from the second substrate to define a second cavity therebetween, and wherein the third substrate comprises:
an upper surface, wherein at least a portion of the upper surface of the third substrate is capable of substantial abutment with at least a portion of the lower surface of the second substrate to substantially enclose a second cavity;
a lower surface;
an upper edge;
a lower edge, wherein the lower edge of the third substrate is hingeably associated with the lower edge of the second substrate;
a first side edge; and
a second side edge;
a fourth substrate, wherein the fourth substrate is spaced apart from the third substrate to define a third cavity therebetween, and wherein the fourth substrate comprises:
an upper surface, wherein at least a portion of the upper surface of the fourth substrate is capable of substantial abutment with at least a portion of the lower surface of the third substrate to substantially enclose a third cavity;
a lower surface;
an upper edge;
a lower edge;
a first side edge; and
a second side edge, wherein the second side edge of the fourth substrate is hingeably associated with the second side edge of the third substrate;
a first cavity, wherein the first cavity comprises an open configuration when the lower surface of the first substrate is spaced apart from the upper surface of the second substrate, and wherein the first cavity comprises a closed configuration when at least a portion of the lower surface of the first substrate is in substantial abutment with at least a portion of the upper surface of the second substrate;
a second cavity, wherein the second cavity comprises an open configuration when the lower surface of the second substrate is spaced apart from the upper surface of the third substrate, and wherein the second cavity comprises a closed configuration when at least a portion of the lower surface of the second substrate is in substantial abutment with at least a portion of the upper surface of the third substrate; and
a third cavity, wherein the third cavity comprises an open configuration when the lower surface of the third substrate is spaced apart from the upper surface of the fourth substrate, and wherein the third cavity comprises a closed configuration when at least a portion of the lower surface of the third substrate is in substantial abutment with at least a portion of the upper surface of the fourth substrate.

11. The scrapbook assembly apparatus according to claim 10, wherein at least one of the group comprising the first substrate, the second substrate, the third substrate, and the fourth substrate comprises a substantially rectangular configuration.

12. The scrapbook assembly apparatus according to claim 10, wherein at least one of the group comprising the upper surface of the first substrate, the upper surface of the second substrate, the upper surface of the third substrate, and the upper surface of the fourth substrate is capable of generating attractive static electricity forces thereon.

13. The scrapbook assembly apparatus according to claim 10, wherein each of the first substrate, the second substrate, and the third substrate further comprises a tab.

14. The scrapbook assembly apparatus according to claim 10, wherein:
the open configuration of the first cavity comprises the first cavity being open between the upper edge of the first substrate and the upper edge of the second substrate, the first side edge of the first substrate and the first side edge of the second substrate, and the second side edge of the first substrate and the second side edge of the second substrate;
the open configuration of the second cavity comprises the second cavity being open between the upper edge of the second substrate and the upper edge of the third substrate, the first side edge of the second substrate and the first side edge of the third substrate, and the second side edge of the second substrate and the second side edge of the third substrate; and
the open configuration of the third cavity comprises the third cavity being open between the upper edge of the third substrate and the upper edge of the fourth substrate, the lower edge of the third substrate and the lower edge of the fourth substrate, and the first side edge of the third substrate and the first side edge of the fourth substrate.

15. The scrapbook assembly apparatus according to claim 10, wherein the fourth substrate is substantially transparent.

16. A scrapbook assembly apparatus, comprising:
a first substrate, wherein the first substrate is substantially transparent, and wherein the first substrate comprises:
an upper surface;
a lower surface;
an upper edge;
a lower edge;
a first side edge; and
a second side edge;
a second substrate, wherein the second substrate is substantially transparent, and wherein the second substrate is spaced apart from the first substrate to define a first cavity therebetween, and wherein the second substrate comprises:
an upper surface, wherein at least a portion of the upper surface of the second substrate is capable of substantial abutment with at least a portion of the lower surface of the first substrate to substantially enclose a first cavity;
a lower surface;
an upper edge;
a lower edge, wherein the lower edge of the second substrate is hingeably associated with the lower edge of the first substrate;
a first side edge; and
a second side edge;
a third substrate, wherein the third substrate is substantially transparent, and wherein the third substrate is spaced apart from the second substrate to define a second cavity therebetween, and wherein the third substrate comprises:
an upper surface, wherein at least a portion of the upper surface of the third substrate is capable of substantial abutment with at least a portion of the lower surface of the second substrate to substantially enclose a second cavity;
a lower surface;
an upper edge;
a lower edge, wherein the lower edge of the third substrate is hingeably associated with the lower edge of the second substrate;
a first side edge; and
a second side edge;
a fourth substrate, wherein the fourth substrate is spaced apart from the third substrate to define a third cavity therebetween, and wherein the fourth substrate comprises:
an upper surface, wherein at least a portion of the upper surface of the fourth substrate is capable of substantial abutment with at least a portion of the lower surface of the third substrate to substantially enclose a third cavity;
a lower surface;
an upper edge;
a lower edge;
a first side edge; and
a second side edge, wherein the second side edge of the fourth substrate is hingeably associated with the second side edge of the third substrate;
a first cavity, wherein the first cavity comprises an open configuration when the lower surface of the first substrate is spaced apart from the upper surface of the second substrate, and wherein the first cavity comprises a closed configuration when at least a portion of the lower surface of the first substrate is in substantial abutment with at least a portion of the upper surface of the second substrate;
a second cavity, wherein the second cavity comprises an open configuration when the lower surface of the second substrate is spaced apart from the upper surface of the third substrate, and wherein the second cavity comprises a closed configuration when at least a portion of the lower surface of the second substrate is in substantial abutment with at least a portion of the upper surface of the third substrate;
a third cavity, wherein the third cavity comprises an open configuration when the lower surface of the third substrate is spaced apart from the upper surface of the fourth substrate, and wherein the third cavity comprises a closed configuration when at least a portion of the lower surface of the third substrate is in substantial abutment with at least a portion of the upper surface of the fourth substrate;
at least one picture or ornamental indicia, wherein the at least one picture or ornamental indicia is releasably secured within the first cavity;
at least one second picture or ornamental indicia, wherein the at least one second picture or ornamental indicia is releasably secured within the second cavity; and
at least one background paper, wherein the at least one background paper is releasably secured within the third cavity.

17. The scrapbook assembly apparatus according to claim 16, wherein at least one of the group comprising the first substrate, the second substrate, the third substrate, and the fourth substrate comprises a substantially rectangular configuration.

18. The scrapbook assembly apparatus according to claim 16, wherein at least one of the group comprising the upper surface of the first substrate, the upper surface of the second substrate, the upper surface of the third substrate, and the upper surface of the fourth substrate is capable of generating attractive static electricity forces thereon.

19. The scrapbook assembly apparatus according to claim 16, wherein each of the first substrate, the second substrate, and the third substrate further comprises a tab.

20. The scrapbook assembly apparatus according to claim 16, wherein:
the open configuration of the first cavity comprises the first cavity being open between the upper edge of the first substrate and the upper edge of the second substrate, the first side edge of the first substrate and the first side edge of the second substrate, and the second side edge of the first substrate and the second side edge of the second substrate;
the open configuration of the second cavity comprises the second cavity being open between the upper edge of the second substrate and the upper edge of the third substrate, the first side edge of the second substrate and the first side edge of the third substrate, and the second side edge of the second substrate and the second side edge of the third substrate; and
the open configuration of the third cavity comprises the third cavity being open between the upper edge of the third substrate and the upper edge of the fourth substrate, the lower edge of the third substrate and the lower edge of the fourth substrate, and the first side edge of the third substrate and the first side edge of the fourth substrate.
